(19) United States
(12) Patent Application Publication
(10) Pub. No.: US 2008/0119611 A1
(43) Pub. Date: May 22, 2008

(54) Coating medium with at least one meltable polymer

(76) Inventor: Wolfgang Klingel, Friolzheim (DE)

Correspondence Address: KRIEGSMAN & KRIEGSMAN, 30 TURNPIKE ROAD, SUITE 9, SOUTHBOROUGH, MA, 01772, US

(21) Appl. No.: 11/973,626

(22) Filed: Oct. 9, 2007

(30) Foreign Application Priority Data
Oct. 6, 2006 (DE) 102006047802.9
Oct. 20, 2006 (DE) 102006049596.9
Sep. 28, 2007 (DE) 10 2007 046 748.8

(51) Int. Cl. C08L 83/05

(52) U.S. Cl. 525/100

(57) ABSTRACT

The present invention concerns a coating medium with at least one meltable polymer. According to the invention provision is made that it contains 1 to 99 percent by weight of at least one amorphous poly-α-olefin and 99 to 1 percent by weight of at least one silane functional moisture-linking polymer.

The present invention concerns a coating medium with at least one meltable polymer.

The coating mediums, which are the subject of the present application, are preferably to be used for the coating and encapsulation by casting of electronic components, in particular printed circuit boards. Such types of coating medium containing meltable polymers serve as a rule for the encapsulation by casting of electronic components, and must have particular characteristics in order to be suitable for this purpose. The melting viscosity should be comparatively low in order that the coating medium flows well during the casting process, reliably covers all the areas to be coated, and can also fill the smallest holes. The coating medium should furthermore have good adhesiveness and a sufficient thermal resistance in order that it adheres firmly and permanently to the substrate to be coated. Finally the coating medium should reliably protect against external influences, in the first instance moisture, but also other contaminants, and in particular should prevent corrosion.

There are already coating mediums on the basis of meltable polymers of known art, which have most of these properties. What is problematical, however, is the thermal resistance. In particular for the coating and the encapsulation by casting of printed circuit boards soft meltable polymers are positively used with a low glass transition temperature T_{G}; these can be worked at comparatively low temperatures, so that the electronic components are protected. Such polymers have however a low thermal resistance, which as a rule does not exceed 100° C. This value is often too low, since the operation of electronic components is linked with a not inconsiderable generation of heat. There are indeed polymers with good thermal resistance that have a higher glass transition temperature T_{G}. This is accompanied, however, by a higher melting point, so that the working temperature is higher. The risk therefore exists that electronic components in particular are excessively stressed by the high working temperature. Moreover polymers of this type also have a comparatively high hardness, which is undesirable for the required use as a coating medium.

It is indeed of known art that polyamides have a large range of variation with regard to hardness and melting point. Polyamides are, however, not suitable for the required use as a coating medium, because they absorb a very large amount of moisture, which is damaging for electronic components in particular.

The object of the present invention accordingly consists in proposing a coating medium that has a sufficient thermal resistance, can be worked easily, acts as a moisture barrier and reliably protects the substrate to be coated from external influences, in particular moisture.

The object is achieved in that the coating medium contains 1 to 99 percent by weight of at least one amorphous poly-α-olefin and 99 to 1 percent by weight of at least one silane functional moisture-linking polymer.

The coating medium according to the invention contains therefore in addition to at least one non-linking meltable polymer at least one other polymer that is moisture-linking, wherein the functional groups which effect the moisture-induced linking have a silane function. After the application of the coating medium according to the invention onto the substrate to be coated this moisture-linking polymer is linked, wherein the linking reaction is effected by the air humidity. There is thus generated a coating that has a matrix of the linked polymer, in which the non-linked amorphous poly-α-olefin is embedded.

The coating medium according to the invention has, presumably on the basis of this mechanism, and according to the type and weight proportions of the components, a thermal resistance of at least 120° C. and more, with a suitable selection of components even of 150° C. or more. In this manner the range of application of the coating medium according to the invention on the basis of a meltable polymer is considerably extended compared with the prior art. The melting viscosity of the coating medium according to the invention can be accurately adjusted by means of the type and quantity of the components and thus adapted to individual requirements. Therefore all parts of the substrate to be coated can be covered with the coating medium according to the invention and the smallest holes can be filled. The option of individual adjustment of the melting viscosity furthermore not only allows substrates to be encapsulated by casting with the coating medium according to the invention, but also for the coating medium to be applied by a spraying process. The coating medium according to the invention can moreover be worked in exactly the same way as the coating medium of previous known art on the basis of meltable polymers, so that the usual devices and equipment for the coating of substrates can work with the coating medium according to the invention without any problems. The coating medium according to the invention furthermore offers extraordinarily good protection, in particular against moisture, and represents a reliably effective moisture barrier. The coating medium according to the invention is furthermore able, in particular in the case of electronic components, such as, for example, printed circuit boards, to attach their components permanently, so that no further adhesion of these components is necessary. The silane functional moisture-linking polymer according to the invention moreover makes the coating medium according to the invention resistant to organic solvents. Finally the coating medium according to the invention offers protection of the coated substrates against mechanical stresses, in particular vibrations.

Advantageous further developments ensue from the dependent claims.

The coating medium according to the invention can, for example, contain 50 percent by weight of the at least one amorphous poly-α-olefin and 50 percent by weight of the at least one silane functional moisture-linking polymer. The quantities of the components always depend on the melting viscosity and thermal resistance desired in the individual case.

Amorphous poly-α-olefins with a viscosity in a range from 1,500 to 2,500 mPaxs as a lower limit and 9,000 to 10,000 mPaxs as a higher limit (in each case at 180° C.), and a softening point of 120 to 140° C., are particularly well-suited for the manufacture of the coating medium according to the invention. Examples of these are the meltable polymers that are still offered under the designations “Hoechst APAO 5090” and “Hoechst Rextac 2715”, wherein the first of these is based on a propylene/ethylene copolymer. In general poly-α-olefins of the monomers ethylene and/or propylene and/or butylene are well-suited for the manufacture of the coating medium according to the invention. Poly-α-olefins of these types are for example described in DE 40 00 695 A1.

The at least one silane functional moisture-linking polymer used for the manufacture of the coating medium according to the invention can, in particular, be a silane terminated polymer and/or a silane functional, preferably amorphous poly-α-olefin. Polymers of these types are, for example, described in DE 102 61 972 A1 and DE 102 10 956 A1. Moreover polymers, which for example have a viscosity in a range from 2,000 to 4,000 mPaxs as a lower limit and 4,000 to 5,000 mPaxs as a higher limit (in each case at 180° C.), and a softening point of 80 to 100° C., are in general well-suited for this purpose. As an example the product “Jowatherm Reaktant EP 15 628.50” can be cited here.

The thermal resistance of the coating medium according to the invention lies for example above 120° C., preferably above 150° C., while the working temperature lies between 100° C. and 170° C. Tests have shown that with a suitable selection of components the encapsulated or sprayed-on coating medium also remains firm and stable at temperatures significantly above 150° C. Substrates thus coated, in particular printed circuit boards, are accordingly also optimally protected at high operating temperatures from external influences, in particular moisture.

The coating medium according to the invention is, for example, easy to work with a melting viscosity at 180° C. of between 1,500 and 2,500 mPaxs.

The following tables show the test values of various examples of mixtures according to the invention; these test values are compared with examples of mixtures with compositions not according to the invention.

The following products have been used for determining the test values:
Bectron MR 3404 amorphous poly-α-olefin from the company Elantas Beck GmbH, Hamburg
Jowatherm-Reaktant POR-Hotmelt silane functional moisture-linking polymer from the Jowat company, Detmold
Bectron PB 3252 2K-polyurethane from the company Elantas Beck GmbH, Hamburg
ISO-PUR K 750 2K-polyurethane from the company Iso-Elektra GmbH, Elze
C1120 meltable resin from the company Bühnen GmbH & Co. K G, Bremen

The MR 3403 and Jowatherm products have been tested in a pure form as well as in the ratios of MR 3404 to Jowatherm of 6:1, 5:1, 4:1, 2:1, 1:1 (all weight to weight). The test results are summarised in Table 1.

Furthermore some of the mixtures listed in Table 1 and also various comparative products have been investigated with reference to their weight loss and their Shore hardness after storage at high temperatures. The results are summarised in Table 2.

TABLE 1

| | | MR3404 | | | | | | Jowatherm |
|---|---|---|---|---|---|---|---|---|
| Properties | Mixtures | (pure) | 6:1 | 5:1 | 4:1 | 2:1 | 1:1 | (pure) |

| | | | | | | | |
|---|---|---|---|---|---|---|---|
| Melting temperature | 110° C. | does not run | does not run | does not run | does not run | does not run | |
| | | at 150° C. | at 160° C. | at 165° C. | at 165° C. | at 165° C. | |
| Shore hardness | A25 | A32 | A35 | A37 | A42 | A45 | A50 |
| Resistance (ethylacetate) | <5 secs | <15 secs | <15 secs | <15 secs | <15 secs | <15 secs | <15 secs |
| Resistance (MPA) | <5 secs | >10 mins | >10 mins | >10 mins | >10 mins | >10 mins | >10 mins |
| Resistance (isopropanol) | <5 secs | >15 mins | >15 mins | | | | |
| Repairability | very good | satisfactory | | poor | no | no | no |
| R_{D} value | 3 × 10¹⁵ | 2.25 × 10¹⁵ | | 2.99 × 10¹⁵ | | 3.34 × 10¹⁵ | 2.7 × 10¹⁵ |
| Flexibility at cold | fractures | fractures | fractures | fractures | | fractures | |
| conditions −23° C. | | | | | | | |
| Flexibility at cold | flexible | flexible | flexible | flexible | | flexible | flexible |
| conditions −10° C. | | | | | | | |
| OF-adhesiveness | 4 | 4 | 3 | 3 | 2 | 1 | 0 |
| Viscosity grading | 1 | 2 | 2 | 2 | 2 | 2 | 3 |
| Viscosity at 180° C. | 2,000 | | | | | | 3,000 |
| Viscosity at 160° C. | 3,000 | | | | | | 6,000 |
| Ageing at 180° C. | | | | | | | |
| Skin formation | | after 8 hrs | after 8 hrs | | after 6.5 | after 5 hrs | after 4 hrs |
| | | | | | hrs | | |
| | | not linked | not linked | | slightly | medium | strongly |
| | | | | | linked | linked | linked |
| Then 18 hours at RT | | no skin | no skin | | tough thick | tough thick | tough thick |
| | | | | | skin | skin | skin |
| Further 15 hours at | no skin | no skin | skin | | tougher | tougher | tougher |
| 180° C. | | | formation | | thicker skin | thicker skin | thicker skin |
| | | | beginning | | | | |
| Pull threads | 10 secs | | | | | 10 secs | |

TABLE 2

| | | ISO-PUR K | | | | | |
|---|---|---|---|---|---|---|---|
| Mixtures | PB 3251 | 750 | C 1120 | 1:1 | 2:1 | 4:1 | 6:1 |

| | Storage for 108 hours at 160° C. | | | | | | |
|---|---|---|---|---|---|---|---|
| Weight loss | 0.86-0.97% | 0.84-0.87% | | | | | |
| Shore hardness (at start) | A61-A64 | A67-A69 | | A41 | A36 | A27 | |
| Shore hardness (at end) | A85 | A87-A88 | | A60 | sample | sample | |
| | | | | | destroyed | destroyed | |
| Comments | | | | | | | |
| | Storage for 178 hours at 150° C. | | | | | | |
| Weight loss | | | | 0.05873 g | 0.06822 g | 0.15685 g | |
| Shore hardness (at start) | | | | | | | |
| Shore hardness (at end) | | | | A46 | A40 | A35 | |
| Comments | | | melts on | | | | sample |
| | | | | | | | destroyed |
| | Storage for 178 hours at 140° C. | | | | | | |
| Weight loss | | | 0.01388 g | 0.03331 g | 0.0523 g | 0.02738 g | 0.02259 g |
| Shore hardness (at start) | | | | | | | |
| Shore hardness (at end) | | | A65 | A47 | A37 | A35 | A32 |
| Comments | | | | | | | |

What is claimed is:

1. A coating medium with at least one meltable polymer,
characterised in that it contains 1 to 99 percent by weight of at least one amorphous poly-α-olefin and 99 to 1 percent by weight of at least one silane functional moisture-linking polymer.

2. The coating medium according to claim 1,
characterised in that it contains 50 percent by weight of an amorphous poly-α-olefin and 50% by weight of the at least one silane functional moisture-linking polymer.

3. The coating medium according to claim 1,
characterised in that the at least one poly-α-olefin is manufactured from the monomers ethylene and/or propylene and/or butylene.

4. The coating medium according to claim 1,
characterised in that the at least one poly-α-olefin is manufactured with a viscosity of 1,500 to 10,000 mPaxs at 180° C., and a softening point of 120 to 140° C.

5. The coating medium according to claim 1,
characterised in that the at least one silane functional moisture-linking polymer is a silane functional, preferably amorphous, poly-α-olefin.

6. The coating medium according to claim 1,
characterised in that the at least one silane functional moisture-linking polymer is a silane terminated polymer.

7. The coating medium according to claim 1,
characterised in that the at least one silane functional moisture-linking polymer is manufactured with a viscosity of 2,000 to 5,000 mPaxs at 180° C., and a softening point of 80 to 120° C.

8. The coating medium according to claim 1,
characterised in that the thermal resistance lies above 120° C., preferably above 150° C.

9. The coating medium according to claim 1,
characterised in that the working temperature is 100 to 170° C.

10. The coating medium according to claim 1,
characterised in that the melting viscosity at 180° C. is between 1,500 and 2,500 mPaxs.

11. A use of the coating medium according to claim 1 for the coating of electrical components, in particular printed circuit boards.
